(19) United States
(12) Patent Application Publication
(10) Pub. No.: US 2025/0232418 A1
(43) Pub. Date: Jul. 17, 2025

(54) METHOD FOR ADAPTIVELY CORRECTING IMAGE SHADOW AND SYSTEM

(71) Applicant: REALTEK SEMICONDUCTOR CORP., HSINCHU (TW)

(72) Inventors: MIN-CHEN HSU, HSINCHU (TW); SHENG-KAI LIN, HSINCHU (TW)

(21) Appl. No.: 19/011,666

(22) Filed: Jan. 7, 2025

(30) Foreign Application Priority Data
Jan. 11, 2024 (TW) 113101137

(51) Int. Cl. G06T 5/80; G06T 5/20; G06T 5/73; G06T 7/11; G06T 7/90

(52) U.S. Cl. CPC G06T 5/80; G06T 5/20; G06T 5/73; G06T 7/11; G06T 7/90; G06T 2207/10024; G06T 2207/20012; G06T 2207/20021

(57) ABSTRACT

A method for adaptively correcting image shadow and a system are provided. In the method, an image captured through a lens is obtained, and pixel values of different color channels of the image are obtained. The image is divided into multiple blocks, and image differences among the blocks are obtained by counting pixel values of each block, so as to filter out similar blocks. Afterwards, multiple block pairs can be obtained based on a filtering result of the similar blocks. A shading rate of the image can be determined according to difference ratios of color channels of the block pairs. Based on the shading rate, shading correction is performed upon the image. If any change occurs to a scene when the shading correction is performed on continuous images, the shading rate is updated according to difference ratios of red and blue channel values of the block pairs.

### CROSS-REFERENCE TO RELATED PATENT APPLICATION

This application claims the benefit of priority to Taiwan Patent Application No. 113101137, filed on Jan. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology for compensating image shading caused by a lens, and more particularly to a method for adaptively correcting image shadow and a system in which lens shading is automatically compensated by being adaptable to different light sources.

### BACKGROUND OF THE DISCLOSURE

A common distortion phenomenon in an imaging system is lens vignetting caused by a lens. The lens vignetting is a phenomenon in which luminance of an image is gradually decreased from a center to a rim when the image is formed as light irradiates on an image sensor through the lens. In other words, the lens is a factor for causing lens shading of the image.

In general, there are two causes for formation of the lens shading. A first type of the lens shading is luminance shading. Since the lens is generally a convex lens that can concentrate most of the light at a central region thereof, the light irradiating on the rim and the corner of the lens may be insufficient, and natural light attenuation caused by an incident angle of the light (approximation with cos⁴θ) may also result in the luminance shading. A second type of the lens shading is color shading. The occurrence of the color shading is relevant to an IR-cut filter inside a lens module.

For a typical camera design, an infrared light filter is installed between the lens and the image sensor of a camera. One purpose of the infrared light filter is to prevent infrared light invisible to the human eye from interfering with the sensor. The common infrared light filters are categorized into absorption-type and reflection-type. One of the advantages of the reflection-type infrared light filter is to cut off most of the infrared light since the reflection-type infrared light filter has a steeper cut-off region. However, the biggest problem of the reflection-type infrared light filter is its requirement on an incident light angle. The incident light angle is also one of the main causes of the color shading. Conversely, the absorption-type infrared light filter is more stable, and shifting of a cut-off wavelength due to the change of the incident light angle does not occur, thereby reducing the problem of color shading. However, the absorption-type infrared light filter has a higher cost.

Several conventional dynamic adjustment methods have been developed to compensate for the lens shading. Since a conventional image-processing process requires a large memory, when a streaming video including continuous frames is processed and a current frame undergoes shading compensation, a following frame cannot reflect the corrected shading compensation in time. Therefore, one of the conventional technologies is to use an additional software computing unit that only performs the shading compensation on a red channel of the frame. However, during actual operations, the problem of lens shading in other channels (e.g., a green channel and a blue channel) also needs to be improved. For example, a conventional method that performs pixel-level operations of hue exchange and grouping is provided. However, the pixel-level operations will consume a large amount of computing power. Furthermore, in the certain conventional technologies, even if a result of horizontal and vertical gradient operations for each of the pixels is obtained, the shading compensation still cannot be effectively embodied due to the hardware limitation.

Differences exist between different imaging modules due to different lenses and sensors thereof, such that a shading compensation process cannot have the same performance on each of the imaging modules. Further, a metamerism phenomenon may occur to the shading compensation process, and different levels of shading compensation are required for various scenes with similar color temperatures. Accordingly, an adaptive shading compensation method that is adaptable to various scenes is needed in the relevant art.

### SUMMARY OF THE DISCLOSURE

In response to the above-referenced technical inadequacy of misjudgment of the conventional lens shading correction technology due to differences among different imaging modules, the present disclosure provides a method for adaptively correcting image shadow and a system. One of the objectives of the method is to obtain a better balance among the different imaging modules, and to prevent a shading compensation error caused by metamerism. Further, the method can achieve lens shading compensation based on statistics of auto white balance and auto exposure without additional computation and hardware requirements.

According to one embodiment of the system, an image-processing unit performs the method. In the method, the system receives images that are captured through a lens, and the image-processing unit is used to retrieve pixel values of each of color channels of the image. The image is divided into multiple blocks, and pixel values of each of the blocks can be calculated. Image differences among the multiple blocks are then obtained to filter out similar blocks. After that, multiple block pairs are obtained according to a filtering result of the similar blocks. Further, difference ratios of the color channels for each of the block pairs can be obtained, so as to determine a shading rate of the image. Shading correction is performed on the image based on the shading rate.

Further, in the method, the similar blocks are filtered out according to one or any combination of hue differences, differences between luminance and saturation, green-channel mean differences, and sharpness differences among the multiple blocks.

The hue differences among the multiple blocks can be determined according to comparisons between red-channel values and green-channel values of the multiple blocks and comparisons between blue-channel values and the green-channel values of the multiple blocks.

Regarding a luminance difference, information of pixel luminance in each of the blocks of the image is firstly obtained, and the information is referred to for calculating an average luminance of each of the blocks and the luminance difference between the blocks. Thus, after a weight value is introduced, the luminance difference between two of the blocks can be amplified. When the luminance difference between the two blocks is smaller than a luminance difference threshold, the two blocks are the similar blocks in the image. Further, a saturation difference between the two blocks can also be used for filtering out luminance-dissimilar blocks.

In order to calculate the green-channel mean difference, the multiple blocks are categorized into an inner block and an outer block, and green-channel means of pixels of the inner block and green-channel means of pixels of the outer block are respectively calculated. In this way, the green-channel mean difference between the inner block and the outer block can be obtained.

A Sobel filter can be used to calculate a gray-level change gradient of each of the multiple blocks, and the gray-level change gradient can be used as the sharpness difference.

Further, the difference ratio of the color channel of the block pair includes a difference ratio between a red-channel value and a blue-channel value. Thus, after summing up the difference ratios between the red-channel values and the blue-channel values of the multiple block pairs, an average of a sum of the difference ratios is calculated. The average is referred to for determining the shading rate of the image.

Still further, a red-channel gain and a blue-channel gain of each of the blocks of the multiple block pairs are calculated, and a moving average filtering scheme is incorporated to filter out a bias extremum.

Further, when the shading rate is employed to perform the shading correction on each of the images, if a scene is determined to be changed according to block difference variations of the multiple block pairs, the shading rate is immediately updated.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating an imaging system applying a method for adaptively correcting image shadow according to one embodiment of the present disclosure;

FIG. 2 is a schematic diagram illustrating a system performing the method for adaptively correcting image shadow according to one embodiment of the present disclosure;

FIG. 3 is a flowchart illustrating the method for adaptively correcting image shadow according to one embodiment of the present disclosure;

FIG. 4 is a schematic diagram depicting an image block according to one embodiment of the present disclosure;

FIG. 5 is another flowchart illustrating the method for adaptively correcting image shadow according to one embodiment of the present disclosure;

FIG. 6 is a flowchart illustrating a process of adaptively correcting a shading rate according to one embodiment of the present disclosure; and

FIG. 7 is a flowchart illustrating a process of determining a scene change in the method for adaptively correcting image shadow according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In an imaging system, physical characteristics of a lens may lead to the problem of lens shading on an image. For example, one of the physical characteristics of the lens is that a central portion of the lens and an edge portion of the lens receive different amounts of light. Even though the conventional lens shading correction (LSC) technology for correcting the problem of lens shading has been developed for years, misjudgment of the lens shading correction technology due to differences among the imaging modules may still occur. Thus, the present disclosure provides a method for adaptively correcting image shadow and a system thereof. One of the objectives of the method is to achieve a better balance among the different imaging modules, and to prevent a shading compensation error caused by metamerism. The method of the present disclosure achieves the goal of lens shading compensation based on statistics of auto white balance and auto exposure without additional computation and hardware requirements.

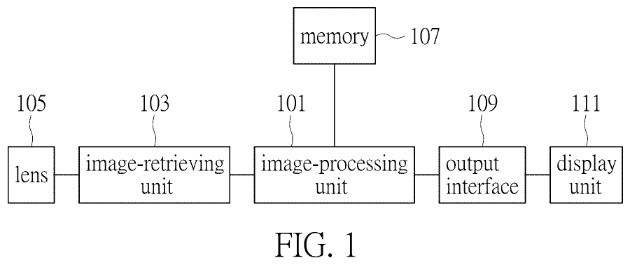

FIG. 1 is a schematic diagram illustrating an imaging system applying the method for adaptively correcting image shadow according to one embodiment of the present disclosure.

The imaging system can be a photographic device or an image-processing device that captures images through a lens. In one of the embodiments of the present disclosure, the method for adaptively correcting image shadow is adapted to the photographic device with poor computing hardware. The photographic device can be a webcam or a photographic module disposed on a display. Further, the method for adaptively correcting image shadow can also be operated in a firmware without any additional software resource or hardware. One of the objectives of the method is to accurately restore the images having errors caused by the lens shading under different color temperatures and environments.

Main components of the imaging system are shown in FIG. 1. The imaging system includes an image-processing unit 101 that is used to process the images. In an aspect, a software program that is executed for implementing the method for adaptively correcting image shadow is loaded into the firmware of the image-processing unit 101. The image-processing unit 101 receives images captured by an image-retrieving unit 103 through a lens 105. The images can be still images or a video produced by continuous photographing. Pixel values in each of color channels of the images can be retrieved and stored to a memory 107.

The image-processing unit 101 performs the method for adaptively correcting image shadow through software or firmware, so as to correct lens vignetting of the images. The images are then encoded to a specific format of data after the correction. An output interface 109 outputs the images to a display unit 111 for displaying. In terms of a webcam or a photographic module of a computer device, the output interface 109 can be a universal serial bus (USB) or any signaling connection that is used to connect with the display unit 111 of the computer device.

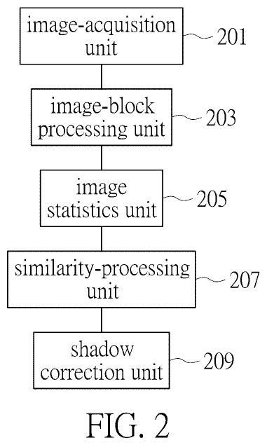

The system operating the method for adaptively correcting image shadow includes functional modules (as shown in FIG. 2) that are implemented by the firmware (such as the image-processing unit 101 of FIG. 1) or software in cooperation with computing hardware. One of the technical concepts is to embed a software program into the image-processing unit 101 of FIG. 1 of the imaging system for implementing the firmware that performs the method for adaptively correcting image shadow in the system. The system, depending on the functions, includes an image-acquisition unit 201 that is used to receive images or convert signals into images, an image-block processing unit 203, an image statistics unit 205, a similarity-processing unit 207 and a shadow correction unit 209.

The system uses the image-acquisition unit 201 to acquire the images, and uses the image-block processing unit 203 to divide the images into M*N blocks averagely or in a specific requirement. The system uses the image statistics unit 205 to count pixel values of each of the blocks, and one of the purposes is to obtain image differences among the multiple blocks for identification of similar blocks. The image-block processing unit 203 can also filter out multiple block pairs.

According to certain embodiments of the present disclosure, one way of filtering out the block pairs is to use the similarity-processing unit 207 that relies on a statistical value of the pixel values of the multiple blocks of the image for determining the similar blocks. For example, the similar blocks can be filtered out according any or any combination of hue differences, differences between luminance and saturation, green-channel mean differences and sharpness differences among the multiple blocks. After that, the multiple block pairs can be obtained based on the similar blocks.

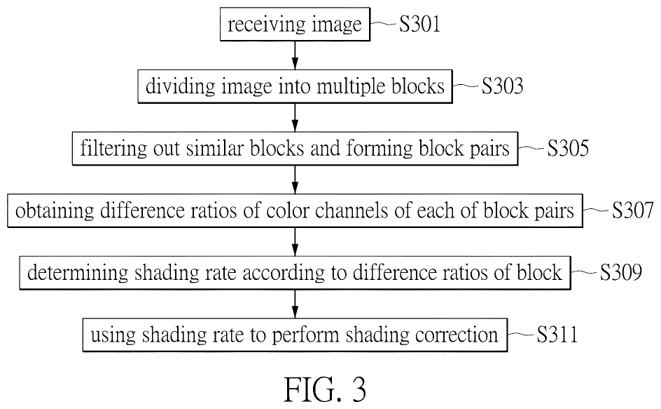

The similarity-processing unit 207 of the system relies on the similarities of the blocks to acquire a sufficient quantity of the block pairs. The shadow correction unit 209 performs shading correction. The method for adaptively correcting image shadow is as shown in FIG. 3, in which a difference ratio of each of the multiple block pairs (such as a difference of each of the color channels) can be used to determine a shading rate of the image. Based on the shading rate, the system performs shading correction on the image.

It should be noted that, during setting of some filtering thresholds, a sufficient quantity of the block pairs obtained by the system should be taken into consideration for effectively performing the shading correction. However, in some cases, the quantity of the block pairs to be filtered may be too small. As such, when the system is performing the shading correction, the filtering threshold can be dynamically adjusted, and a weight can be set for obtaining a sufficient quantity of the block pairs.

Further, when the system performs automatic shading correction, a buffer that is configured for performing the shading correction in the firmware (e.g., the image-processing unit 101 of FIG. 1) of the system is provided, so as to prevent over-processing the images in real time. For example, the buffer can be a memory block (e.g., a portion of the memory 107 of FIG. 1) that is used for the system to perform the shading correction. The shading correction process may be omitted when the quantity of the block pairs obtained in the shading correction process is insufficient.

FIG. 3 is a flowchart illustrating the method for adaptively correcting image shadow operated in the system according to one embodiment of the present disclosure.

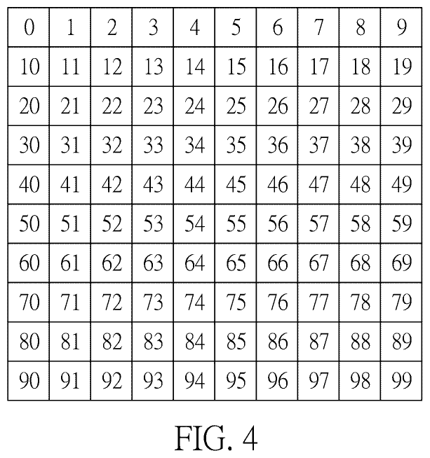

When the system receives images and retrieves pixel values of each of color channels from the images (step S301), each of the images is divided into multiple blocks based on a need (step S303). The size and the quantity of the blocks can be determined based on a specific need. For example, the image is divided into multiple blocks in a specific manner according to real-time computing power of the system. FIG. 4 is a schematic diagram illustrating image blocks of the present disclosure, in which the image is divided into 10*10 blocks that are configured to be numbered from 0 to 99.

Next, the similar blocks can be filtered out for forming the block pairs (step S305). One way of filtering out the similar blocks is based on similarities among the blocks by counting the pixel values of every block, e.g., calculating an average of the statistical values of the pixels of the multiple blocks and image differences among the multiple blocks. According to one embodiment of the present disclosure, the similar blocks can be filtered out according any or any combination of hue differences, differences between luminance and saturation, green-channel mean (Gₘₑₐₙ) differences and sharpness differences among the multiple blocks.

According to one embodiment of a process of determining the similarities of the blocks in the method for adaptively correcting image shadow, a similarity threshold needs to be determined. The similarity threshold can be determined based on the above-mentioned various pixel statistical values. For example, the similarity threshold can be calculated according to the hue differences and the differences between luminance and saturation among the multiple blocks. The similarity threshold acting as a reference for filtering out the similar blocks can be dynamically adjusted according to the sharpness differences among the multiple blocks.

In an exemplary example, the system can retrieve statistical values (such as values of hue (h), saturation(s), and luminance (l)) of an HSL color space from an image that is described by color channels that include a red (R) channel, a green (G) channel, and a blue (B) channel.

In an example where the hue differences among the multiple blocks are used as a reference for determining the similar blocks, the hue differences can be determined according to comparisons between red-channel values and green-channel values of the multiple blocks and comparisons between blue-channel values and the green-channel values of the multiple blocks. When the hue difference is smaller than a hue difference threshold set by the system, the similar blocks of the image can be determined.

The luminance differences among the blocks acts as a reference for determining the block similarity. For example, information of pixel luminance in each of the blocks of the image is firstly obtained, and the information is referred to for calculating an average luminance of each of the blocks and the luminance difference between the blocks. In certain embodiments, a weight value is introduced for amplifying the luminance difference between the blocks, and the similar blocks are obtained from the image if the luminance difference between two blocks is smaller than a luminance difference threshold. Further, in order to avoid the problem of erroneous determination of similarity, a saturation difference between the two blocks can also be used to filter out luminance-dissimilar blocks since an error may occur when the similarity is determined only by the luminance difference.

In an example where the green-channel mean difference acts as a reference for determining the block similarity, the multiple blocks divided from the image are categorized into an inner block and an outer block, and green-channel means of the pixels of the inner block and the outer block can be respectively calculated for obtaining the green-channel mean difference between the inner block and the outer block.

In an example where the sharpness difference is used for determining the block similarity, a Sobel filter is used to calculate a gray-level change gradient of each of the blocks, and the gray-level change gradient is used as a reference for determining the sharpness difference. Further, the Sobel filter is used for finding an edge of an object in the image. In the process of edge finding, the image firstly undergoes a grayscale processing, and then a local variation of grayscale between pixels of the image can be obtained by scanning the image. The edge in the image can be determined based on the local variation of grayscale. For example, an edge is formed between an object and a background of the image, and a change gradient can be calculated. In the present example, the gray-level change gradient is referred to as the sharpness difference.

The block pairs can be obtained according to the block similarities among the blocks that are exemplarily shown in FIG. 4. In FIG. 4, a block number “0” (“block 0”) and a block number “4” (“block 4”) can be paired to be a block pair 0 (“pair 0”). A block number “9” (“block 9”) and a block number “5” (“block 5”) are paired to be a block pair 1 (“pair 1”). A block number “90” (“block 90”) and a block number “94” (“block 94”) are paired to be a block pair 2 (“pair 2”). A block number “99” (“block 99”) and a block number “95” (“block 95”) are paired to be a block pair 3 (“pair 3”). A block number “21” (“block 21”) and a block number 23 (“block 23”) are paired to be a block pair 4 (“pair 4”). A bock number “28” (“block 28”) and a block number 26 (“block 26”) are paired to be a block pair 5 (“pair 5”). It should be noted that the scheme to form these block pairs is not limited to above example, but is based on the statistical pixel values of actual images.

After the multiple block pairs are filtered out based on the block similarities, a difference ratio of each of the block pairs is calculated. The difference ratio is, for example, a difference ratio of color channels (step S307). Accordingly, the system can determine the shading rate according to the difference ratios of the multiple block pairs (step S309). The difference ratios act as the references for the system to perform shading correction based on the shading rate (step S311).

According to one embodiment of the present disclosure, the difference ratio of the block pair mainly indicates a difference between the color channels of the pixels. For example, the difference ratio can be the difference between a red-channel (R channel) value and a blue-channel (B channel) value of each of the block pairs. Therefore, after the difference ratios between the different color channels of the block pairs are obtained, the difference ratios between the color channels (e.g., the red-channel value and the blue-channel value) of the multiple block pairs can be summed up for calculating an average, and the average is referred to for determining the shading rate of an image.

It should be noted that the shading rate is determined based on a degree of the image shadow caused by the lens, and is used to compensate an exposure gain of each of the blocks. Therefore, the shading rate is a combination of multiple gain compensation values for different color channels of a portion of the image with the shadow caused by the lens. Thus, the shading rate can also be adjusted by referring to numerical relationships of the red-channel value, the blue-channel value, and the difference ratio there-between. The main objective of adjusting the shading rate is to keep a color difference of the image smaller than a specific threshold. The shading rate is then recorded in a memory. Afterwards, when a scene is determined to be changed, the scene change may cause change of the gain or color temperature to exceed a certain degree. At this time, the shading rate is required to be dynamically updated for adapting to the shading correction process of the present scene.

It should be noted that, in step S305 of filtering out the similar blocks for formation of the block pairs, image stability still needs to be maintained even if the system requires accuracy in the process of shading correction. Hence, a moving average filtering scheme is introduced in the method for adaptively correcting image shadow, so as to filter out a bias extremum. According to the above embodiment of the present disclosure, the system calculates a red-channel gain (RGain) and a blue-channel gain (BGain) of each of the blocks of the multiple block pairs. The moving average filtering scheme is used to filter out the bias extremum, such that an excessive bias caused by one single block pair can be prevented. In this way, the stability of the shading correction process can be guaranteed.

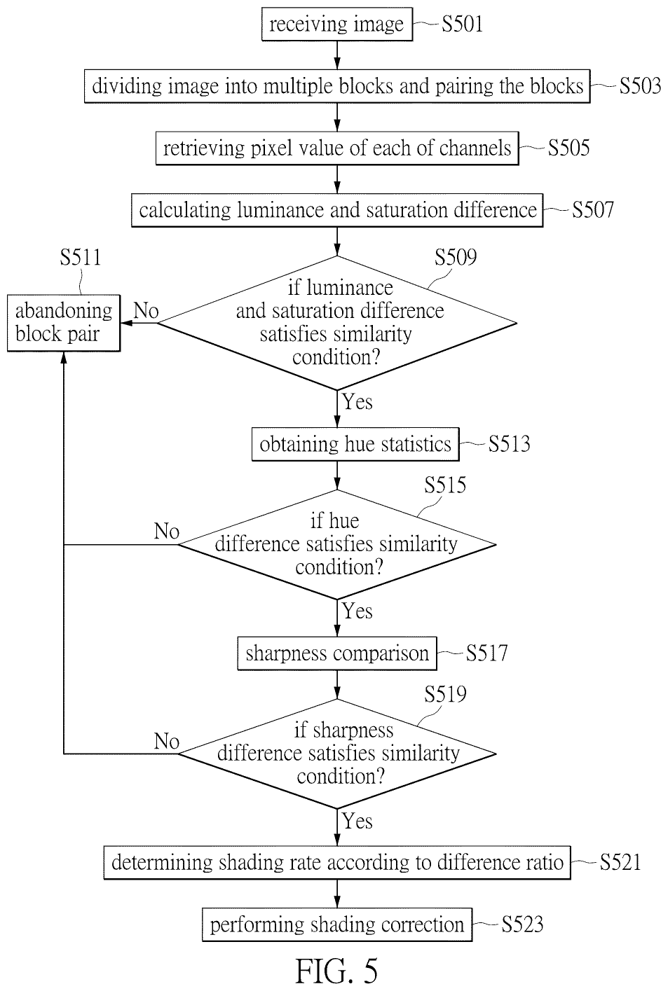

Reference is made to FIG. 5, which is a flowchart illustrating the method for adaptively correcting image shadow according to one embodiment of the present disclosure in more detail.

After an image is received (step S501), the image is divided into multiple blocks, and the blocks are configured to be paired (step S503). The calculation of block similarity is used to exclude the dissimilar blocks through multiple steps. The pixel values of color channels of the image are obtained (step S505). As described in the above embodiment, information of hue, saturation, and luminance of the pixels in an HSL color space can be obtained, such that a difference between luminance and saturation can be calculated (step S507). After that, whether or not the difference between luminance and saturation meets a similarity condition is determined (step S509). According to certain embodiments, a luminance difference between two of the blocks is calculated and compared with a luminance difference threshold, and the two blocks are determined to be similar if the luminance difference is smaller than the luminance difference threshold. Further, a saturation difference between the two blocks is also calculated for filtering out the luminance-dissimilar blocks.

When the blocks are determined to be dissimilar (represented as “no”) based on the information of luminance and saturation, the related block pairs are abandoned (step S511). Conversely, if the blocks are determined to be similar (represented as “yes”) based on the information of luminance and saturation, a hue statistics for each of the blocks can be continuously obtained (step S513). The hue difference among the blocks can be obtained according to comparison results that are obtained by comparing the red-channel values and the green-channel values of the multiple blocks and comparing the blue-channel values and the green-channel values of the blocks. The hue difference is then compared with a hue difference threshold set by the system for determining whether or not the hue difference between every two blocks meets a similarity condition (step S515).

If the hue difference does not satisfy the similarity condition (represented as “no”), the related block pair is abandoned (step S511). Conversely, if the hue difference meets the similarity condition (represented as “yes”), the process proceeds to a sharpness comparison (step S517).

The calculation of the sharpness difference between the blocks can be implemented by the Sobel filter described in the above embodiment. The Sobel filter is used to calculate a gray-level change gradient of each of the blocks and to determine if the sharpness difference meets a similarity condition (step S519). If the sharpness difference of the blocks does not meet the similarity condition (represented as “no”), the related block pair is abandoned (step S511). Conversely, if the sharpness difference of the blocks meets the similarity condition (represented as “yes”), the block pair is confirmed, and the multiple block pairs that meet the similarity condition can thus be obtained.

After that, in order to obtain the shading rate used to perform shading correction, the difference ratio of each of the block pairs needs to be obtained. The difference ratio can be a ratio of the color channels between the block pairs. For example, a difference ratio between the red-channel value and the blue-channel value is used as the difference ratio used for shading correction. Further, after summing up the difference ratios between the red-channel values and the blue-channel values of the multiple block pairs, an average is calculated. The average is referred to for determining the shading rate of the image (step S521), and then the shading rate is used to perform shading correction (step S523).

In the shading correction process, for the multiple blocks divided from the image, the difference ratio of the color channels between the block pairs is used to obtain adjustment values for auto exposure and auto white balance, so as to establish a shading correction curve. Based on the shading correction curve, the system performs lens shading correction.

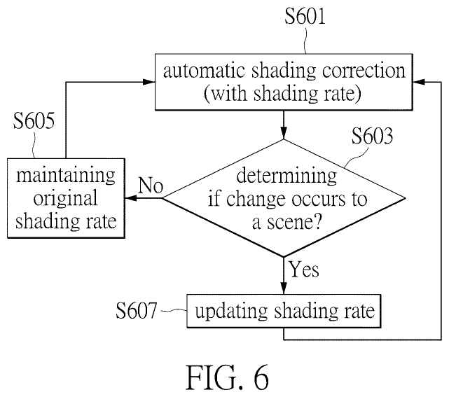

More particularly, when the method for adaptively correcting image shadow is performed on continuous images, the system may encounter scene change. Due to the scene change, the shading rate is required to be updated. Reference is made to FIG. 6, which is a flowchart illustrating a process of adaptively updating the shading rate according to one embodiment of the present disclosure.

When the scene change is determined, the values for auto white balance and auto exposure are required to be adjusted during image processing since scenes are different from one another in color temperature and luminance. The scene change can be one of the conditions for triggering lens shading correction. In one embodiment of the present disclosure, when the system performs the method for adaptively correcting image shadow, the shading rate that is determined in real time is used for performing automatic shading correction (step S601). Whether or not the scene is changed is continuously determined during the process of shading correction (step S603).

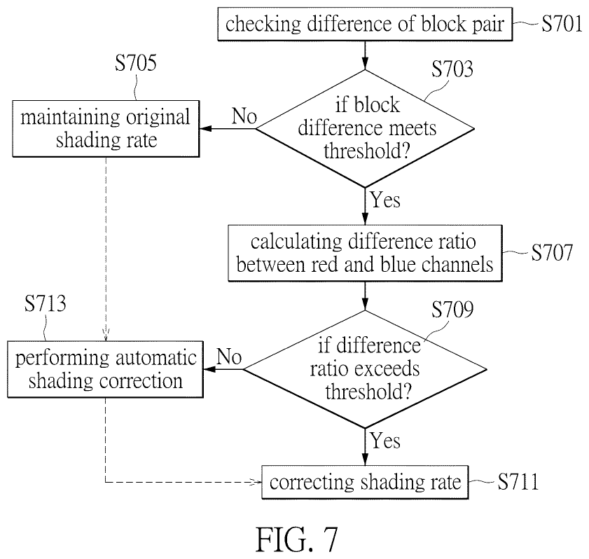

In the step of determining the scene change, reference is made to a flowchart shown in FIG. 7, in which the scene change can be determined based on block difference variations of the multiple block pairs. For example, in the process of determining the shading rate, the difference ratio between the red-channel value and the blue-channel value between each of the block pairs is continuously calculated, so as to determine whether or not the scene is changed.

Further, the system can rely on changes of a quantity and difference ratios of the multiple block pairs to determine whether or not the scene is changed. When the quantity of the block pairs with the block difference variations larger than a difference threshold is larger than a quantity threshold, there is the occurrence of scene change (represented as “yes”). Accordingly, the shading rate is updated according to difference ratios of the red-channel values and the blue-channel values of the block pairs (step S607). After that, the shading correction is performed. Conversely, if the difference ratio of the block pair is not larger than the difference threshold, or the quantity of the block pairs having the difference ratios larger than the difference threshold is not larger than the quantity threshold, the scene is determined not to be changed, or the degree of scene change does not require adjustment of the shading rate (represented as “no”). That is, the original shading rate can be maintained (step S605).

Similarly, after determining the scene and updating the shading rate, a buffer is required to perform the shading correction process for preventing over-compensating the image shadow.

Reference is made to FIG. 7, which is a flowchart illustrating a process of determining a scene change according to one embodiment of the present disclosure.

When the system performs the method for adaptively correcting image shadow, the system constantly checks the difference between the block pairs (step S701), and determines whether or not the difference between the block pairs reaches a threshold (step S703). The threshold can be the difference between the block pairs as described in FIG. 6 and the quantity of the block pairs with the differences reaching the difference threshold. If the difference between the block pairs does not reach the threshold (represented as “no”), the original shading rate is maintained (step S705), and the process of automatic shading correction continues (step S713). If the difference between the block pairs reaches the threshold (represented as “yes”), the difference ratios between the red-channel values and the blue-channel values of the multiple block pairs are calculated (step S707). The difference ratios are referred to for determining whether or not the present shading rate is required to be adjusted. The shading rate is required to be adjusted if the difference ratio is larger than the threshold set by the system (represented as “yes”) (step S711), and then the process of automatic shading correction is performed (step S713).

According to certain embodiments of the present disclosure, the process of adjusting the shading rate adopts an approximation method. For example, the red-channel value and the blue-channel value of each of the blocks of the block pair are determined to be small if the difference ratio between the red-channel value and the blue-channel value of each of the block pairs is larger than a ratio threshold set by the system. In this situation, the shading rate is adjusted to be larger for increasing both the red-channel value and the blue-channel value. Conversely, the red-channel value and the blue-channel value of each of the blocks of the block pair are determined to be large if the difference ratio between the red-channel value and the blue-channel value of each of the block pairs is smaller than the ratio threshold, and the shading rate is adjusted to be smaller for reducing both the red-channel value and the blue-channel value.

In conclusion, according to the above embodiments of the method for adaptively correcting image shadow and the system of the present disclosure, the main objective of the method is to solve the problems of luminance shading and color shading caused by uneven refracted lights that are formed due to optical characteristics of the camera lens. Through the method and the system, the shading rate can be automatically adjusted under different light sources, so as to improve the problem of color shading due to the metamerism. In the method, the similar blocks in the image are firstly determined, and then the block pairs are filtered out. The shading correction is conducted based on difference characteristics of these block pairs. It should be noted that the shading rate can be adjusted in real time based on the scene changes of the continuous images, and the shading correction begins only after the scene changes become stable. For example, the shading correction is conducted after the processes of auto exposure (AE) and auto white balance (AWB) are stable.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for adaptively correcting image shadow, comprising:
receiving an image, and retrieving pixel values of each of color channels of the image;
dividing the image into multiple blocks, calculating pixel values of each of the blocks, and obtaining an image difference among the multiple blocks to filter out similar blocks;
obtaining multiple block pairs according to a filtering result of the similar blocks;
calculating a difference ratio of each of the multiple block pairs;
determining a shading rate of the image according to the difference ratios of the multiple block pairs; and
performing shading correction on the image based on the shading rate.

2. The method according to claim 1, wherein the similar blocks are filtered out according to one or any combination of hue differences, differences between luminance and saturation, green-channel mean differences, and sharpness differences among the multiple blocks.

3. The method according to claim 2, wherein a similarity threshold is calculated according to the hue differences and the differences between luminance and saturation among the multiple blocks; wherein the similarity threshold is dynamically adjusted according to the sharpness difference among the multiple blocks, so as to act as a reference for filtering out the similar blocks.

4. The method according to claim 2, wherein the hue differences among the multiple blocks are determined according to comparisons between red-channel values and green-channel values of the multiple blocks and comparisons between blue-channel values and the green-channel values of the multiple blocks.

5. The method according to claim 2, wherein information of pixel luminance in each of the blocks of the image is obtained for calculating an average luminance of each of the blocks and a luminance difference between the blocks.

6. The method according to claim 5, wherein a weight value is introduced for amplifying the luminance difference between the blocks; wherein, when the luminance difference between two of the blocks is smaller than a luminance difference threshold, the two blocks are the similar blocks in the image.

7. The method according to claim 6, wherein a saturation difference between the two blocks is used for filtering out luminance-dissimilar blocks.

8. The method according to claim 2, wherein the multiple blocks divided from the image are categorized into an inner block and an outer block, and green-channel means of pixels of the inner block and green-channel means of pixels of the outer block are respectively calculated, so as to obtain the green-channel mean difference between the inner block and the outer block.

9. The method according to claim 2, wherein a Sobel filter is used to calculate a gray-level change gradient of each of the multiple blocks, and the gray-level change gradient is used as the sharpness difference.

10. The method according to claim 1, wherein the difference ratio of each of the block pairs is a difference ratio between a red-channel value and a blue-channel value.

11. The method according to claim 10, wherein, after summing up the difference ratios between the red-channel values and the blue-channel values of the multiple block pairs, an average of a sum of the difference ratios is calculated, and the average is referred to for determining the shading rate of the image.

12. The method according to claim 1, wherein a red-channel gain and a blue-channel gain of each of the blocks of the multiple block pairs are calculated, and a moving average filtering scheme is incorporated to filter out a bias extremum.

13. The method according to claim 1, wherein the method is applied to continuous images, and the shading rate is employed to perform the shading correction on each of the images and determine whether or not any scene is changed; wherein, in response to determining that the scene is changed, the shading rate is updated.

14. The method according to claim 13, wherein whether or not any scene is changed is determined based on block difference variations of the multiple block pairs.

15. The method according to claim 14, wherein, when a quantity of the block pairs in which the block difference variations are larger than a difference threshold is larger than a quantity threshold, the shading rate is updated according to difference ratios between red-channel values and blue-channel values of the multiple block pairs.

16. A system for performing a method for adaptively correcting image shadow, the system comprising:
an image-processing unit, wherein the image-processing unit is configured to perform the method, and the method includes:
receiving an image captured through a lens, and retrieving pixel values of each of color channels of the image;
dividing the image into multiple blocks, calculating pixel values of each of the blocks, and obtaining an image difference among the multiple blocks to filter out similar blocks;
obtaining multiple block pairs according to a result of the similar blocks;
calculating a difference ratio of each of the multiple block pairs;
determining a shading rate of the image according to the difference ratios of the multiple block pairs; and
performing shading correction with the shading rate.

17. The system according to claim 16, wherein, in the method, the similar blocks are filtered out according to one or any combination of hue differences, differences between luminance and saturation, green-channel mean differences, and sharpness differences among the multiple blocks.

18. The system according to claim 17, wherein the difference ratio of each of the block pairs is a difference ratio between a red-channel value and a blue-channel value; wherein, after summing up the difference ratios between the red-channel values and the blue-channel values of the multiple block pairs, an average of a sum of the difference ratios is calculated, and the average is referred to for determining the shading rate of the image.

19. The system according to claim 16, wherein the method is applied to continuous images, and the shading rate is employed to perform the shading correction on each of the images and determine whether or not any scene is changed; wherein, in response to determining that the scene is changed, the shading rate is updated.

20. The system according to claim 19, wherein whether or not any scene is changed is determined based on block difference variations of the multiple block pairs; wherein, when a quantity of the block pairs in which the block difference variations are larger than a difference threshold is larger than a quantity threshold, the shading rate is updated according to difference ratios between red-channel values and blue-channel values of the multiple block pairs.
